(19) United States
(12) Patent Application Publication
(10) Pub. No.: US 2022/0237523 A1
(43) Pub. Date: Jul. 28, 2022

(54) ELECTRONIC DEVICE FOR PERFORMING FEDERATED LEARNING USING HARDWARE SECURE ARCHITECTURE AND FEDERATED LEARNING METHOD USING THE SAME

(71) Applicant: Samsung Electronics Co., Ltd., Suwon-si (KR)

(72) Inventors: Soonhong KWON, Suwon-si (KR); Seolheui KIM, Suwon-si (KR); Junbum SHIN, Suwon-si (KR)

(21) Appl. No.: 17/582,873

(22) Filed: Jan. 24, 2022

Related U.S. Application Data
(63) Continuation of application No. PCT/KR2021/012965, filed on Sep. 23, 2021.

(30) Foreign Application Priority Data
Jan. 22, 2021 (KR) 10-2021-0009751

(51) Int. Cl. G06N 20/20

(52) U.S. Cl. CPC G06N 20/20

(57) ABSTRACT

Provided are an electronic device and server for performing federated learning, and a method of controlling the same for federated learning. A method, performed by the server, of performing federated learning with the electronic device, includes: transmitting, to the electronic device, requesting data requesting transmission of a federated learning parameter used to refine a core artificial intelligence model built in the server; receiving, from the electronic device, federated learning data including the federated learning parameter; identifying whether a result of federated learning performed by the electronic device is trustable, based on the federated learning data; and refining the core artificial intelligence model, based on a result of the identifying, wherein the receiving of the federated learning data includes receiving federated learning secure data stored in a hardware secure architecture of the electronic device, and the identifying of whether the result of the federated learning is trustable includes identifying whether the result of the federated learning is trustable, based on the federated learning secure data.

### CROSS-REFERENCE TO RELATED APPLICATIONS

This application is a continuation of International Application No. PCT/KR2021/012965 designating the United States, filed on Sep. 23, 2021, in the Korean Intellectual Property Receiving Office and claiming priority to Korean Patent Application No. 10-2021-0009751, filed on Jan. 22, 2021, in the Korean Intellectual Property Office, the disclosures of which are incorporated by reference herein in their entireties.

### BACKGROUND

### Field

The disclosure relates to an electronic device and server for performing federated learning, and a method of controlling the same for federated learning.

### Description of Related Art

An artificial intelligence (AI) system may refer to a computer system that implements human-level intelligence, and unlike an existing rule-based smart system, a machine learns, makes decisions, and becomes smarter by itself. The more the AI system is used, the more a recognition rate is improved and the more a user's taste is accurately understood, and thus, the existing rule-based smart system is gradually being replaced by a deep learning-based AI system.

AI technology includes machine learning (deep learning) and element technologies using machine learning.

Machine learning may refer to an algorithm technology that classifies/learns features of pieces of input data by itself, and an element technology is a technology using a machine learning algorithm such as deep learning and includes technical fields, such as linguistic understanding, visual understanding, inference/prediction, knowledge expression, and operation control.

As machine learning, cloud machine learning has been mainly performed, wherein a server receives, from a plurality of electronic devices, raw data or training data to which preprocessing is applied, and trains an AI model built in the server using received data.

Federated learning that is more advanced cloud machine learning is also being performed.

Federated learning may refer to machine learning in which a plurality of electronic devices train AI models built in the plurality of electronic devices using training data stored in the plurality of electronic devices, respectively, and only information (for example, a parameter) about changes in refined AI models is transmitted to a server. A core AI model built in the server is refined using the information about the changes in the AI models, wherein the information is transmitted via a cloud. Also, refined matters of the core AI model built in the server are transmitted to each of the plurality of electronic devices, and thus, the AI models built in the plurality of electronic devices are refined.

In federated learning, original data is not directly transmitted to a cloud, and thus, personal information of a user of each of the plurality of electronic devices may be protected.

However, federated learning may be exposed to an attacker who is interrupting the federated learning. For example, an electronic device performing federated learning may provide wrong information to a server, and thus, a core AI model built in the server may be refined in a wrong direction.

Accordingly, a method of verifying whether an electronic device has performed federated learning correctly and guaranteeing reliability of the federated learning is required.

### SUMMARY

Embodiments of the disclosure provide an electronic device and server for performing federated learning using a hardware secure architecture, and a method of controlling the electronic device and server.

Embodiments of the disclosure provide a method, performed by a server, of verifying falsification of a federated learning parameter stored in a hardware secure architecture of an electronic device.

Embodiments of the disclosure provide a method, performed by a server, of verifying whether an electronic device has correctly trained an artificial intelligence (AI) model.

Embodiments of the disclosure provide a method, performed by a server, of verifying whether an electronic device has transmitted a maliciously performed training result to the server.

Embodiments of the disclosure provide a method, performed by a server, of verifying whether an electronic device is a normal device that performs federated learning.

Embodiments of the disclosure provide an operation to be performed by a server that has received, from an electronic device, a federated learning parameter of which reliability is not approved.

However, the technical problems to be solved by embodiments of the disclosure are not limited to those described above.

According to an example embodiment of the disclosure, a method, performed by a server, of performing federated learning with an electronic device, includes: transmitting, to the electronic device, requesting data for requesting transmission of a federated learning parameter used to refine a core artificial intelligence model built in the server; receiving, from the electronic device, federated learning data including the federated learning parameter; identifying whether a result of federated learning performed by the electronic device is trustable, based on the federated learning data; and refining the core artificial intelligence model, based on a result of the identifying, wherein the receiving of the federated learning data includes receiving federated learning secure data stored in a hardware secure architecture of the electronic device, and the identifying of whether the result of the federated learning is trustable includes identifying whether the result of the federated learning is trustable, based on the federated learning secure data.

The receiving of the federated learning secure data may include: receiving first hash data of the federated learning parameter stored in the hardware secure architecture of the electronic device, and the identifying of whether the result of the federated learning is trustable may include: obtaining second hash data from the federated learning parameter received from the electronic device; and identifying an integrity of the result of the federated learning by comparing the first hash data to the second hash data.

The receiving of the first hash data may include: receiving a first message authentication code stored in the hardware secure architecture of the electronic device, and the identifying of whether the result of the federated learning is trustable may include: obtaining a second message authentication code, based on a secure key included in the requesting data; and identifying that the electronic device is an electronic device authenticated by the server by comparing the first message authentication code to the second message authentication code, wherein the first message authentication code may be generated by the electronic device based on the secure key included in the requesting data received from the server.

The receiving of the federated learning secure data may include: receiving, by the electronic device, the federated learning secure data including federated learning performance information about a result of performing training on an artificial intelligence model built in the electronic device, and the identifying of whether the result of the federated learning is trustable may include identifying whether the result of the federated learning is trustable, based on the federated learning performance information.

The federated learning performance information may include: information of training time about a time taken by the electronic device to perform the training on the artificial intelligence model built in the electronic device, and the identifying of whether the result of the federated learning is trustable may include identifying whether the electronic device has trained the artificial intelligence model built in the electronic device, by performing outlier detection on the information of training time.

The identifying of whether the result of the federated learning is trustable may include: identifying whether the electronic device has trained the artificial intelligence model built in the electronic device, by performing the outlier detection on the information of training time, based on at least one of information about a size of the federated learning parameter, information about a specification of the electronic device included in the federated learning performance information, information about a use rate of hardware used by the electronic device to train the artificial intelligence model, or information about an algorithm used by the electronic device to train the artificial intelligence model.

The federated learning performance information may include: an outlier detection value generated based on outlier detection being performed on training data used by the electronic device to train the artificial intelligence model built in the electronic device, and the identifying of whether the result of the federated learning is trustable may include identifying a reliability degree of the training data used by the electronic device by comparing the outlier detection value to a certain value.

The federated learning performance information may include: federated learning identification information including identification information related to the federated learning performed by the electronic device, and the identifying of whether the result of the federated learning is trustable may include: identifying whether the electronic device is trustable, based on first federated learning identification information received from the electronic device and second federated learning identification information pre-registered in the server.

The first federated learning identification information may include data encoded by the electronic device using a hash function, the second federated learning identification information may include data encoded by the server using a hash function, and the identifying of whether the result of the federated learning is trustable may include identifying whether the electronic device is trustable by comparing the first federated learning identification information to the second federated learning identification information.

According to an example embodiment of the disclosure, a server configured to perform federated learning with an electronic device, includes: a communication interface comprising communication circuitry; a memory storing one or more instructions; and a processor configured to execute the one or more instructions to: control the communication interface to transmit, to the electronic device, requesting data requesting transmission of a federated learning parameter used to refine a core artificial intelligence model built in the server and receive, from the electronic device, federated learning data including the federated learning parameter; identify whether a result of the federated learning performed by the electronic device is trustable, based on the federated learning data; refine the core artificial intelligence model, based on a result of the identifying; control the communication interface to receive federated learning secure data stored in a hardware secure architecture of the electronic device; and identify whether the result of the federated learning is trustable, based on the federated learning secure data.

The processor may be further configured to execute the one or more instructions to: control the communication interface to receive first hash data of the federated learning parameter stored in the hardware secure architecture of the electronic device; obtain second hash data from the federated learning parameter received from the electronic device; and identify an integrity of the result of the federated learning by comparing the first hash data to the second hash data.

The processor may be further configured to execute the one or more instructions to: control the communication interface to receive a first message authentication code stored in the hardware secure architecture of the electronic device; obtain a second message authentication code based on a secure key included in the requesting data; and identify that the electronic device is an electronic device authenticated by the server by comparing the first message authentication code to the second message authentication code, wherein the first message authentication code may be generated by the electronic device based on the secure key included in the requesting data received from the server.

The processor may be further configured to execute the one or more instructions to: control the communication interface to receive the federated learning secure data including federated learning performance information about a result of performing, by the electronic device, training on an artificial intelligence model built in the electronic device; and identifying whether the result of the federated learning is trustable, based on the federated learning performance information.

The federated learning performance information may include information of training time about a time taken by the electronic device to perform the training on the artificial intelligence model built in the electronic device, and the processor may be further configured to execute the one or more instructions to: identify whether the electronic device has trained the artificial intelligence model built in the electronic device, by performing outlier detection on the information of training time.

The processor may be further configured to execute the one or more instructions to: identify whether the electronic device has trained the artificial intelligence model built in the electronic device, by performing the outlier detection on the information of training time, based on at least one of information about a size of the federated learning parameter, information about a specification of the electronic device included in the federated learning performance information, information about a use rate of hardware used by the electronic device to train the artificial intelligence model, or information about an algorithm used by the electronic device to train the artificial intelligence model.

The federated learning performance information may include an outlier detection value generated based on outlier detection being performed on training data used by the electronic device to train the artificial intelligence model built in the electronic device, and the processor may be further configured to execute the one or more instructions to: identify a reliability degree of the training data used by the electronic device by comparing the outlier detection value to a certain value.

The federated learning performance information may include federated learning identification information including identification information related to the federated learning performed by the electronic device, and the processor may be further configured to execute the one or more instructions to: identify whether the electronic device is trustable, based on first federated learning identification information received from the electronic device and second federated learning identification information pre-registered in the server.

The first federated learning identification information may include data encoded by the electronic device using a hash function, the second federated learning identification information may include data encoded by the server using a hash function, and the processor may be further configured to execute the one or more instructions to: identify whether the electronic device is trustable by comparing the first federated learning identification information to the second federated learning identification information.

The processor may be further configured to execute the one or more instructions to: perform a protecting operation on the core artificial intelligence model, based on the result of the federated learning identified to be untrustable.

According to an example embodiment of the disclosure, a non-transitory computer-readable recording medium has recorded thereon a program for executing, on a computer, at least one embodiment of the disclosed method.

According to an example embodiment of the disclosure, an application stored in a recording medium executes at least one function among embodiments of the disclosed method.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example of a method, performed by a plurality of electronic devices and a server, of performing federated learning, according to various embodiments;

FIG. 2 is a signal flow diagram illustrating an example method, performed by a server that exchanged data with an electronic device, of refining a core artificial intelligence (AI) model, according to various embodiments;

FIG. 3 is a diagram illustrating an example of a method, performed by an electronic device, of transmitting data to a server using a hardware secure architecture, according to various embodiments;

FIG. 4 is a flowchart illustrating an example method, performed by a server, of identifying an integrity of a result of federated learning performed by an electronic device, according to various embodiments;

FIG. 5 is a flowchart illustrating an example method, performed by a server, of identifying authentication of an electronic device that transmitted federated learning data, according to various embodiments;

FIG. 6 is a flowchart illustrating an example method, performed by a server, of identifying whether an electronic device that transmitted federated learning data has trained an AI model built in the electronic device, according to various embodiments;

FIG. 7 is a flowchart illustrating an example method, performed by a server, of identifying a reliability degree of training data used by an electronic device that transmitted federated learning data to train an AI model built in the electronic device, according to various embodiments;

FIG. 8 is a flowchart illustrating an example method, performed by a server, of identifying a reliability degree of an electronic device that transmitted federated learning data, according to various embodiments;

FIG. 9 is a block diagram illustrating an example configuration of an electronic device according to various embodiments;

FIG. 10 is a block diagram illustrating an example software module of a memory included in an electronic device, according to various embodiments;

FIG. 11 is a block diagram illustrating an example configuration of a server according to various embodiments; and

FIG. 12 is a block diagram illustrating an example software module of a memory included in a server, according to various embodiments.

### DETAILED DESCRIPTION

Throughout the disclosure, the expression “at least one of a, b or c” indicates only a, only b, only c, both a and b, both a and c, both b and c, all of a, b, and c, or variations thereof.

The disclosure describes the principles of the disclosure and discloses various example embodiments of the disclosure. The various example embodiments of the disclosure may be implemented in various forms. The various example embodiments of the disclosure may be implemented independently or in a combination of at least two embodiments of the disclosure.

Throughout the disclosure, like reference numerals denote like elements. The present specification does not describe all elements of the embodiments of the disclosure, and generic content in the technical field of the disclosure or redundant content of the embodiments of the disclosure may be omitted. In the disclosure, the term “part” or “portion” may be a hardware component, such as a processor or a circuit, and/or a software component executed by a hardware component, such as a processor, and according to embodiments of the disclosure, a plurality of parts or portions may be realized by one unit or element, or one part or portion may include a plurality of units or elements. Hereinafter, operation principles and embodiments of the disclosure will be described with reference to accompanying drawings.

Various embodiments of the disclosure may be represented by functional block configurations and various processing operations. Some or all of these functional blocks may be implemented by various numbers of hardware and/or software configurations that perform particular functions. For example, the functional blocks of the disclosure may be implemented by one or more microprocessors or by circuit configurations for a certain function. Also, for example, the functional blocks of the disclosure may be implemented in various programming or scripting languages. The functional blocks may be implemented by algorithms executed in one or more processors. In addition, the disclosure may employ general techniques for electronic environment setting, signal processing, and/or data processing. Terms such as “mechanism”, “element”, “means”, and “configuration” may be used widely and are not limited as mechanical and physical configurations.

Throughout the disclosure, when a part is “connected” to another part, the part may not only be “directly connected” to the other part, but may also be “electrically connected” to the other part with another element in between. In addition, when a part “includes” a certain element, the part may further include another element instead of excluding the other element, unless otherwise stated.

A connection line or a connection member between components shown in the drawings is merely a functional connection and/or a physical or circuit connection. In an actual device, connections between components may be represented by various functional connections, physical connections, or circuit connections that are replaceable or added.

Further, the terms including ordinal numbers such as “first”, “second”, and the like used in the present disclosure may be used to describe various components, but the components should not be limited by the terms. The above terms may be used to distinguish one component from another. For example, the present disclosure recites first data and second data, but ordinal numbers used here are only to distinguish different pieces of data, and thus data is not limited by the ordinal numbers.

A server according to the disclosure may use an artificial intelligence (AI) model to infer or predict a reliability degree of a result of federated learning.

Inference-based prediction may refer to a technology for logically inferring and predicting information by determining the information, and includes knowledge (probability)-based reasoning, optimization prediction, preference-based planning, and recommendation.

A function related to AI according to the disclosure operates via a processor and a memory. The processor may be configured as one or more processors. In this case, the one or more processors may include a general-purpose processor such as, for example, and without limitation, a central processing unit (CPU), an application processor (AP), a digital signal processor (DSP), a dedicated graphics processor such as a graphics processing unit (GPU) or a vision processing unit (VPU), a dedicated AI processor such as a neural processing unit (NPU), or the like. The one or more processors may control input data to be processed according to predefined operation rules or an AI model stored in the memory. When the one or more processors are a dedicated AI processor, the dedicated AI processor may be designed with a hardware structure specialized for processing a specific AI model. The processor may perform a preprocessing operation of converting data applied to the AI model into a form suitable to be applied to the AI model.

The AI model may be generated via training. Training refers to the predefined operation rules or AI model being set to perform desired characteristics (or purposes) are generated by training a basic AI model with a learning algorithm that utilizes a large number of training data. The training process may be performed by a device for performing AI or a separate server and/or system. Examples of the learning algorithm may include supervised learning, unsupervised learning, semi-supervised learning, and reinforcement learning, but are not limited thereto.

The AI model may include a plurality of neural network layers. Each of the neural network layers may include a plurality of weight values, and performs a neural network arithmetic operation via an arithmetic operation between an arithmetic operation result of a previous layer and the plurality of weight values. A plurality of weight values in each of the neural network layers may be optimized by a result of training the AI model. For example, the plurality of weight values may be updated to reduce or minimize a loss or cost value obtained by the AI model during the training process. An artificial neural network may include a deep neural network (DNN) and may include, for example, a convolutional neural network (CNN), a DNN, a recurrent neural network (RNN), a restricted Boltzmann machine (RBM), a deep belief network (DBN), a bidirectional recurrent DNN (BRDNN), a deep Q-network (DQN), or the like, but is not limited thereto.

The AI model may be generated by learning a plurality of pieces of text data and image data input as training data, according to a certain standard. The AI model may generate result data by performing a trained function in response to input data, and output the result data.

The AI model may include a plurality of AI models trained to perform at least one function.

Hereinafter, various example embodiments of the disclosure will be described in greater detail with reference to accompanying drawings.

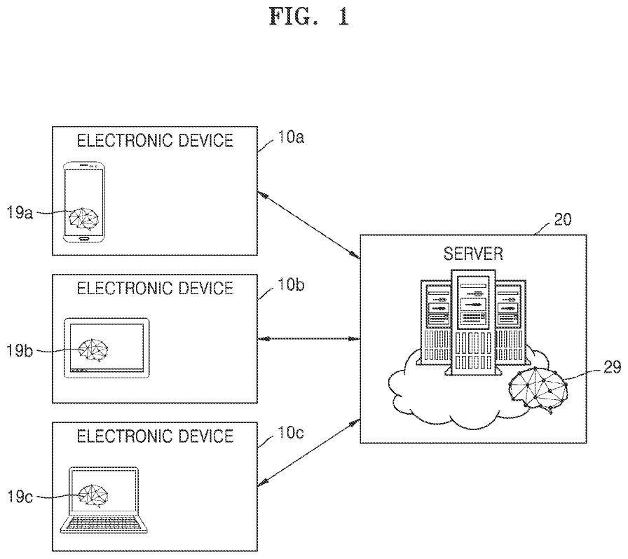

FIG. 1 is a diagram illustrating an example of a method, performed by electronic devices 10a through 10c and a server 20, of performing federated learning, according to various embodiments. FIG. 1 illustrates three electronic devices 10a through 10c for convenience of description, and the number of electronic devices is not limited thereto. Also, FIG. 1 illustrates one server 20 for convenience of description, but the number of servers is not limited thereto. According to an embodiment of the disclosure, a plurality of servers for providing a cloud service may be integrally referred to as the server 20.

Referring to FIG. 1, each of the electronic devices 10a through 10c may include an operating device, such as, for example, and without limitation, a mobile device (for example, a smartphone or a tablet personal computer (PC)), a general-purpose computer (PC), or the like, which is capable of transmitting and receiving data to and from the server 20 via a network.

Each of the electronic devices 10a through 10c may include an Internet of things (IoT) device, a home hub device (for example, a router or an interactive AI speaker) connected to various IoT devices and the server 20, or the like.

According to an embodiment of the disclosure, the electronic devices 10a through 10c may include operating devices, such as mobile devices (for example, smartphones or tablet PCs), general-purpose computers, or servers, in which AI models 19a through 19c are built, respectively.

According to an embodiment of the disclosure, the plurality of electronic devices 10a through 10c may perform certain operations using the AI models 19a through 19c, respectively. For example, the plurality of electronic devices 10a through 10c may perform operations of identifying and classifying input data, and outputting data corresponding to the input data, using the AI models 19a through 19c, respectively.

According to an embodiment of the disclosure, the plurality of electronic devices 10a through 10c may obtain training data to refine the AI models 19a through 19c, respectively. The training data may include input data input by a user of each of the plurality of electronic devices 10a through 10c, and output data corresponding to the input data.

According to an embodiment of the disclosure, the server 20 may transmit or receive data to or from at least one electronic device from among the plurality of electronic devices 10a through 10c.

For example, the server 20 may transmit or receive data required to generate a network for federated learning, to or from at least one electronic device. For example, the server 20 may receive public keys from the plurality of electronic devices 10a through 10c. The public key may refer to data indicating that an electronic device performing federated learning corresponds to a device performing federated learning with an external device (for example, another electronic device or server). The public key may include identification information of each of the plurality of electronic devices 10a through 10c performing federated learning. The server 20 may transmit, to the plurality of electronic devices 10a through 10c, broadcasting data generated using the received public keys.

As another example, the server 20 may transmit or receive data for performing federated learning, to or from at least one of the plurality of electronic devices 10a through 10c.

For example, the server 20 may transmit, to the plurality of electronic devices 10a through 10c performing federated learning, requesting data requesting transmission of a federated learning parameter used to refine a core AI model 29. The requesting data transmitted by the server 20 to at least one of the plurality of electronic devices 10a through 10c may include a secure key of the server 20. The secure key may refer to data used to generate an authentication code added to data transmitted or received between the server 20 and the electronic device, so as to authenticate, by the server 20, the electronic device performing federated learning with the server 20.

The server 20 may receive, from each of the plurality of electronic devices 10a through 10c, federated learning data including the federated learning parameter. The federated learning parameter may refer to at least some of parameters/weights of the AI models 19a through 19c refined when the plurality of electronic devices 10a through 10c train the AI models 19a through 19c, respectively, and used by the server 20 to refine the core AI model 29. According to an embodiment of the disclosure, each of the plurality of electronic devices 10a through 10c may generate the federated learning parameter as vector-type data.

The server 20 may receive, from each of the plurality of electronic devices 10a through 10c, federated learning secure data for identifying whether a result of federated learning performed by each of the plurality of electronic devices 10a through 10c is trustable. In other words, the federated learning secure data may refer to data used by the server 20 to identify whether each of the plurality of electronic devices 10a through 10c has normally performed federated learning. For example, the federated learning secure data may include data such as hash data obtained by each of the plurality of electronic devices 10a through 10c by applying the federated learning parameter on a hash function, a message authentication code, federated learning performance information about a result of federated learning performed by each of the plurality of electronic devices 10a through 10c, and federated learning identification information that is identification information related to federated learning performed by each of the plurality of electronic devices 10a through 10c.

According to an embodiment of the disclosure, the federated learning secure data may include data stored in a hardware secure architecture of the electronic device. The hardware secure architecture may refer, for example, to a memory secure zone encoded based on hardware (central processing unit (CPU)/graphics processing unit (GPU)) such that data is not forged/falsified via external access. The hardware secure architecture is generally referred as a trust zone, a secure zone, a secure memory, or a trusted execution environment (TEE), and will be commonly referred to as a secure zone hereinafter.

The server 20 may store received data in a database (DB). The server 20 may perform various operations using the received data. For example, the server 20 may refine the core AI model 29 built in the server 20 using the federated learning parameter received from at least one of the plurality of electronic devices 10a through 10c. As another example, the server 20 may use the federated learning secure data received from at least one of the plurality of electronic devices 10a through 10c to identify whether the result of federated learning performed by an electronic device that has transmitted the federated learning data is trustable.

According to an embodiment of the disclosure, when it is identified that the result of federated learning performed by the electronic device is not trustable, the server 20 may perform a protecting operation on the core AI model 29. For example, the server 20 may remove the received federated learning parameter without reflecting the federated learning parameter to federated learning. Alternatively, the server 20 may request at least one of the electronic devices 10a through 10c to retransmit the federated learning parameter. Alternatively, the server 20 may drop out at least one of the electronic devices 10a through 10c from federated learning.

The server 20 may transmit the federated learning parameter of the refined core AI model 29 to each of the plurality of electronic devices 10a through 10c. The plurality of electronic devices 10a through 10c may refine the AI models 19a through 19c, respectively, using the received federated learning parameter of the core AI model 29.

According to an embodiment of the disclosure, a core AI model built in a server may be correctly refined by verifying whether an electronic device has correctly performed federated learning and guaranteeing reliability of a result of the federated learning.

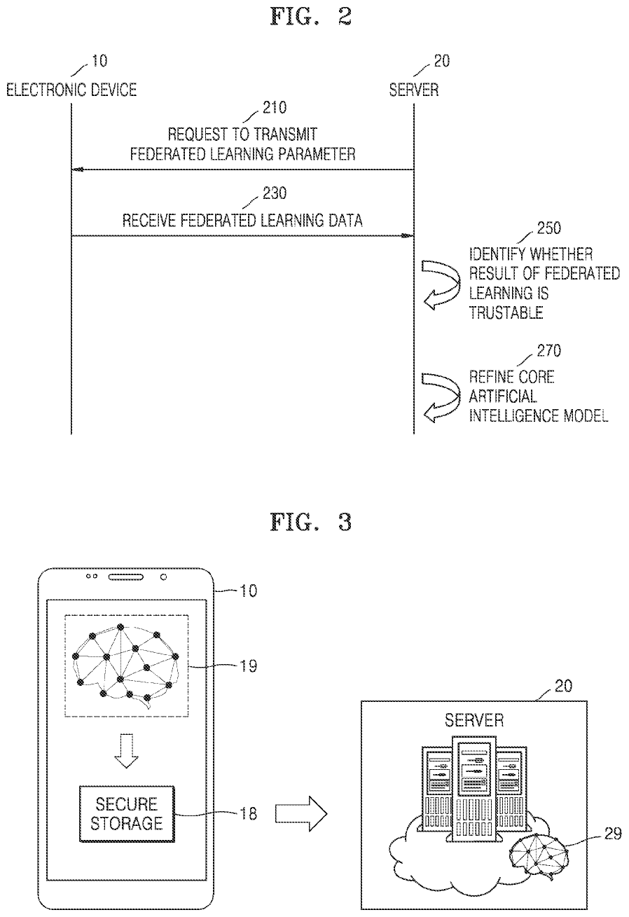

FIG. 2 is a signal flow diagram illustrating an example method, performed by the server 20 that exchanged data with an electronic device 10, of refining the core AI model 29, according to various embodiments.

Referring to operation 210, the server 20 may transmit, to the electronic device 10, requesting data requesting transmission of a federated learning parameter.

According to an embodiment of the disclosure, the core AI model 29 may be built in the server 20. The server 20 may perform federated learning with the electronic device 10 to refine the core AI model 29.

According to an embodiment of the disclosure, the server 20 may transmit or receive data required to generate a network for federated learning, to or from at least one electronic device 10. For example, the server 20 may receive, from the electronic device 10, a public key including identification information of the electronic device 10. The server 20 may transmit or receive data to or from the electronic device 10, based on the identification information of the electronic device 10. The server 20 may transmit the requesting data to the electronic device 10 at every certain time.

According to an embodiment of the disclosure, the server 20 may transmit the requesting data including a secure key of the server 20 to the at least one electronic device 10 performing federated learning. The secure key of the server 20 may refer to data used to generate an authentication code added to data transmitted or received between the server 20 and the electronic device 10, so as to authenticate, by the server 20, the electronic device 10.

Referring to operation 230, the server 20 may receive federated learning data from the electronic device 10.

According to an embodiment of the disclosure, the electronic device 10 may generate the federated learning data including the federated learning parameter, in response to the requesting data received from the server 20. The electronic device 10 may train an AI model using training data, thereby obtaining at least some of parameters of the refined AI model and/or at least some of updated weights among weights of neural network layers of the AI model. The electronic device 10 may generate the federated learning parameter including the obtained at least some of parameters/weights. The electronic device 10 may generate the federated learning parameter as vector-type data.

According to an embodiment of the disclosure, the electronic device 10 may generate the federated learning data including federated learning secure data. The federated learning secure data may refer to data used by the server 20 to identify whether the electronic device 10 has normally performed federated learning. For example, the electronic device 10 may generate, as the federated learning secure data, hash data generated by applying the federated learning parameter to a hash function, a message authentication code, and federated learning performance information about a result of performing federated learning by the electronic device 10. Also, the electronic device 10 may generate, as the federated learning performance information, information of training time about a time taken by the electronic device 10 to train the built AI model. The electronic device 10 may generate an outlier detection value by performing outlier detection on the training data used to train the AI model built in the electronic device 10. The electronic device 10 may generate, as the federated learning performance information, federated learning identification information that is identification information related to federated learning performed by the electronic device 10. The electronic device 10 may store the generated federated learning secure data in a hardware secure architecture (hereinafter, referred to as a secure zone).

According to an embodiment of the disclosure, the electronic device 10 may generate federated learning data including a weight indicating an importance of the federated learning parameter. The weight of the electronic device 10 may include information related to the number of times the AI model built in the electronic device 10 has been trained.

Referring to operation 250, the server 20 may identify whether a result of federated learning performed by the electronic device 10 is trustable.

The server 20 may identify whether the result of federated learning performed by the electronic device 10 is trustable, based on the federated learning secure data received from the electronic device 10.

According to an embodiment of the disclosure, the server 20 may identify an integrity of the result of federated learning performed by the electronic device 10, based on the hash data of the federated learning parameter received from the electronic device 10.

According to an embodiment of the disclosure, the server 20 may identify that the electronic device 10 is an electronic device authenticated by the server 20, based on the message authentication code received from the electronic device 10.

According to an embodiment of the disclosure, the server 20 may identify whether the electronic device 10 has trained the AI model built in the electronic device 10, based on the information of training time received from the electronic device 10.

According to an embodiment of the disclosure, the server 20 may identify a reliability degree of the training data used by the electronic device 10 to train the AI model built in the electronic device 10, based on the outlier detection value received from the electronic device 10.

According to an embodiment of the disclosure, the server 20 may identify whether the electronic device 10 is trustable, based on the federated learning identification information received from the electronic device 10.

Referring to operation 270, the server 20 may refine the core AI model using the received federated learning parameter.

According to an embodiment of the disclosure, the server 20 may refine the core AI model using the federated learning parameter received from the electronic device 10, based on a result of identifying that the result of federated learning performed by the electronic device 10 is trustable. For example, the server 20 may refine the core AI model by applying the federated learning parameter received from the electronic device 10 to the core AI model. As another example, the server 20 may update weights of neural network layers of the core AI model to the updated weights among the weights of the neural network layers of the AI model of the electronic device 10.

According to an embodiment of the disclosure, the server 20 may perform a protecting operation on the core AI model, based on a result of identifying that the result of federated learning performed by the electronic device 10 is not trustable. For example, the server 20 may remove the federated learning parameter received from the electronic device 10 without reflecting the federated learning parameter to federated learning. The server 20 may request the electronic device 10 to retransmit the federated learning parameter. Alternatively, the server 20 may drop out the electronic device 10 from federated learning.

FIG. 3 is a diagram illustrating an example of a method, performed by the electronic device 10, of transmitting data to the server 20 using a hardware secure architecture, according to various embodiments.

Referring to FIG. 3, the electronic device 10 may obtain federated learning performance information about a result of performing federated learning, by training an AI model 19 using training data. The electronic device 10 may store the federated learning performance information in a secure zone 18.

According to an embodiment of the disclosure, the electronic device 10 may store, in the secure zone 18, an updated parameter Param of the AI model 19, as a result of training the AI model 19. The electronic device 10 may store, in the secure zone 18, hash data H(Param) obtained by applying the parameter Param on a hash function.

For example, the electronic device 10 may execute an instruction (for example, tensor to device/GPU) for training the AI model 19 using input training data, and execute an instruction (for example, tensor to CPU) for storing, in the secure zone 18, the parameter Param/hash data H(Param) generated as a result of training the AI model 19.

According to an embodiment of the disclosure, the electronic device 10 may generate a message authentication code using a certain algorithm, based on a secure key of the server 20. The message authentication code may refer to a code added to data such that it may be verified whether the data has been modified (revised, deleted, inserted, or the like). The electronic device 10 may store the message authentication code in the secure zone 18. The electronic device 10 may store, in the secure zone 18, a hash message authentication code obtained by applying the message authentication code to a hash function. The electronic device 10 may transmit, to the server 20, a federated learning parameter by adding the message authentication code/hash message authentication code to the federated learning parameter.

According to an embodiment of the disclosure, the electronic device 10 may store, in the secure zone 18, the federated learning performance information about a result of training the AI model 19. The electronic device 10 may store the federated learning performance information in the secure zone 18 whenever the AI model 19 is trained.

For example, the electronic device 10 may store, in the secure zone 18, information of training time about a time taken to train the AI model 19. For example, the electronic device 10 may store, in the secure zone 18, a start/end time of the training of the AI model 19 and a training performance time of the AI model 19, whenever the AI model 19 is refined.

As another example, the electronic device 10 may store, in the secure zone 18 whenever the AI model 19 is refined, federated learning auxiliary information, such as information about a specification of the electronic device 10, information about a use rate of hardware used to train the AI model 19, information about an algorithm used to train the AI model 19, and information about a size of the federated learning parameter generated by training the AI model 19.

As another example, the electronic device 10 may perform outlier detection on training data used to train the AI model 19. The electronic device 10 may store, in the secure zone 18, an outlier detection value about the training data.

As another example, the electronic device 10 may store, in the secure zone 18, federated learning identification information that is identification information related to federated learning performed by the electronic device 10. For example, the electronic device 10 may store, in the secure zone 18, the federated learning identification information, such as identification information of the electronic device 10, identification information of an application training the AI model 19, identification information of the AI model 19, and identification information of the secure zone 18. Also, the electronic device 10 may store, in the secure zone 18, the federated learning identification information encoded by being applied to a hash function.

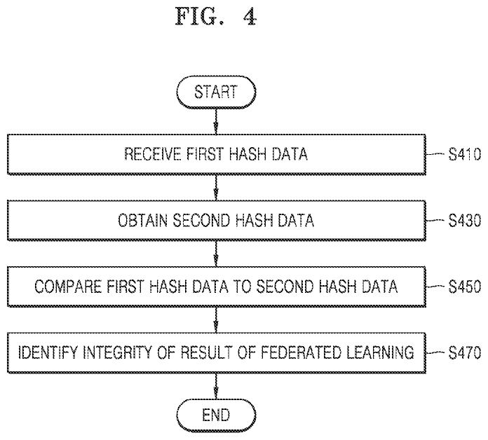

FIG. 4 is a flowchart illustrating an example method, performed by the server, of identifying an integrity of a result of federated learning performed by the electronic device, according to various embodiments. Referring to FIG. 4, the server may identify the integrity of the result of federated learning performed by the electronic device, based on hash data received from the electronic device.

According to an embodiment of the disclosure, the electronic device may train the AI model using training data. For example, the electronic device may train the AI model using, as the training data, physical data (for example, a height, a weight, blood pressure, pulse, or the like) of a user, medical data (for example, a medical image, an illness history, a medication history, a medical treatment history, or the like) of the user, and the like.

According to an embodiment of the disclosure, the electronic device may identify an updated parameter Param of the AI model. The electronic device may identify, as the parameter Param, an updated weight from among weights of neural network layers of the AI model.

According to an embodiment of the disclosure, the electronic device may store, in the secure zone, the updated parameter Param of the AI model. Also, the electronic device may store, in the secure zone, hash data H(Param) obtained by applying the parameter Param on a hash function.

According to an embodiment of the disclosure, the server and the electronic device may have pre-determined a certain algorithm as the hash function. For example, the server may transmit, to the electronic device, information about an algorithm determined as the hash function by adding the information to requesting data.

Referring to operation S410, the server may receive first hash data from the electronic device. The electronic device may transmit, to the server, federated learning data including the first hash data stored in the secure zone together with a federated learning parameter. Here, the first hash data may refer to data obtained as the electronic device applies the parameter Param to the hash function.

Referring to operation S430, the server may obtain second hash data from a federated learning parameter Param′ received from the electronic device. Here, the second hash data may refer to data applied as the server applies the federated learning parameter Param′ to the hash function.

Referring to operation S450, the server may compare the first hash data to the second hash data. For example, the server may compare the first hash data received from the secure zone of the electronic device to the second hash data obtained as the server applies the federated learning parameter Param′ received from the electronic device to the hash function.

Referring to operation S470, the server may identify the integrity of the result of federated learning performed by the electronic device, based on a result of comparing the first hash data to the second hash data.

The first hash data stored in the secure zone of the electronic device is data that is unable to be forged/falsified by the outside. The second hash data obtained by the server is generated using a same function as the hash function used to generate the first hash data. The first hash data and the second hash data being the same indicates that the federated learning parameter Param′ transmitted by the electronic device to the server has not been forged/falsified. Accordingly, the server may identify the integrity of the result of federated learning performed by the electronic device, based on the result of comparing the first hash data to the second hash data.

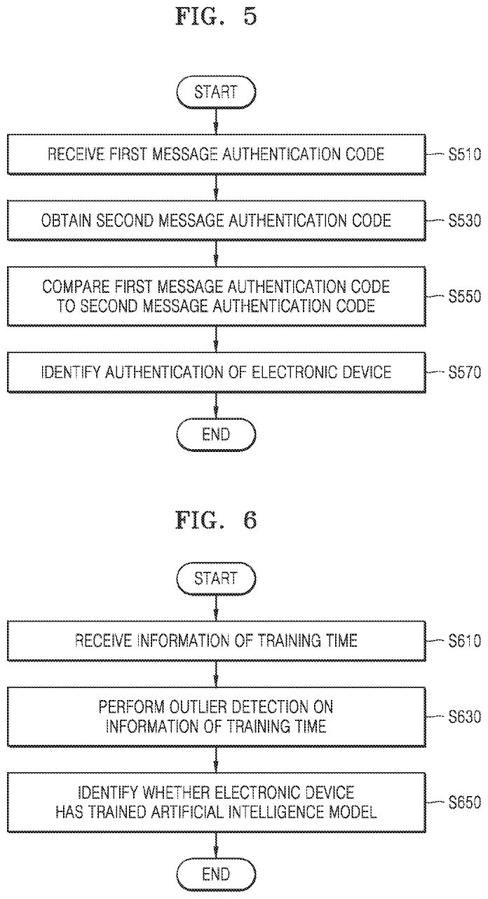

FIG. 5 is a flowchart illustrating an example method, performed by the server, of identifying authentication of the electronic device that transmitted federated learning data, according to various embodiments. Referring to FIG. 5, the server may identify the authentication of the electronic device that performed federated learning, based on a message authentication code received from the electronic device.

According to an embodiment of the disclosure, the server may transmit a secure key of the server to the electronic device authenticated by the server. For example, the server may transmit the secure key of the server to the electronic device while transmitting or receiving data for forming a network for federated learning to or from the electronic device. As another example, the server may transmit, to the electronic device, requesting data including the secure key of the server.

According to an embodiment of the disclosure, the server and the electronic device may have pre-determined a certain algorithm for generating the message authentication code. For example, the server may transmit, to the electronic device, information about an algorithm determined as a unidirectional hash function. Also, the electronic device may generate the message authentication code using the secure key of the server received from the server. The electronic device may store the generated message authentication code in the secure zone.

Referring to operation S510, the server may receive first message authentication code from the electronic device. The electronic device may transmit, to the server, federated learning data including the first message authentication code stored in the secure zone together with a federated learning parameter. Here, the first message authentication code may refer to a message authentication code generated as the electronic device applies the secure key of the server to the pre-determined algorithm. The first message authentication code may be data encoded by the electronic device using a hash function.

Referring to operation S530, the server may obtain a second message authentication code based on the secure key of the server. Here, the second message authentication code may refer to a message authentication code generated as the server applies the secure key of the server to the pre-determined algorithm. The second message authentication code may be data encoded by the server using the hash function.

Referring to operation S550, the server may compare the first message authentication code to the second message authentication code. For example, the server may compare the first message authentication code received from the secure zone of the electronic device to the second message authentication code obtained by the server using the secure key of the server.

Referring to operation S570, the server may identify whether the electronic device has been authenticated by the server, based on a result of comparing the first message authentication code to the second message authentication code.

Because the server transmits the secure key of the server only to the electronic device authenticated by the server, only the electronic device authenticated by the server is able to generate the message authentication code. The first message authentication code and the second message authentication code being the same indicates that the electronic device that transmitted the first message authentication code to the server is a device authenticated by the server.

The first message authentication code and the second message authentication code being the same when the first message authentication code and the second message authentication code are data encoded using the same hash function indicates that the integrity of the first message authentication code is recognized. Accordingly, the server may identify whether the electronic device has been authenticated by the server, based on the first message authentication code of which the integrity is recognized.

FIG. 6 is a flowchart illustrating an example method, performed by the server, of identifying whether the electronic device that transmitted federated learning data has trained the AI model built in the electronic device, according to various embodiments. Referring to FIG. 6, the server may identify whether the electronic device has trained the AI model, based on information of training time received from the electronic device.

According to an embodiment of the disclosure, the server may store, in the secure zone, federated learning performance information about a result of training the AI model whenever the AI model built in the electronic device is trained. For example, the electronic device may store, in the secure zone, the information of training time about a time taken by the electronic device to train the AI model, such as a start/end time of training of the AI model or a training performance time of the AI model. Also, the electronic device may store, in the secure zone, federated learning auxiliary information related to the time taken to train the AI model, such as information about a specification of the electronic device, information about a use rate of hardware used to train the AI model, information about an algorithm used to train the AI model, and information about a size of a federated learning parameter generated by training the AI model.

Referring to operation S610, the server may receive the information of training time from the electronic device. The electronic device may transmit, to the server, the information of training time stored in the secure zone. The electronic device may transmit, to the server, the federated learning auxiliary information stored in the secure zone.

Referring to operation S630, the server may perform outlier detection on the information of training time received from the electronic device.

According to an embodiment of the disclosure, the server may perform outlier detection on first information of training time received from the electronic device, by performing a principal component analysis (PCA) on the first information of training time. For example, the server may obtain a feature of the first information of training time by reducing and reconstructing a dimension of the first information of training time via PCA. The server may perform the outlier detection on the first information of training time by comparing the feature of the first information of training time to features of a plurality of pieces of second information of training time pre-stored in a DB. A feature of information of training time may be a principal component of the information of training time.

According to an embodiment of the disclosure, the server may perform the outlier detection on the first information of training time via a statistic analysis with respect to the first information of training time received from the electronic device.

For example, the server may perform the outlier detection on the first information of training time by comparing the first information of training time to the pieces of second information of training time about a training time taken by an electronic device having a similar specification as the electronic device to refine an AI model.

As another example, the server may identify a distance between the first information of training time and the pieces of second information of training time by applying the first information of training time to a statistic model generated from the pieces of second information of training time. The server may perform the outlier detection on the first information of training time, based on the identified distance. The server may perform the outlier detection on the first information of training time using at least one statistic model from among a normal model, a regression model, and a mixed model. For example, the server may perform the outlier detection on the first information of training time, based on a distance between a first period included in the first information of training time and an average value of second periods included in the pieces of second information of training time, via a certain method (for example, a Brubbs test, a Mahalanobis distance test, a student t test, a Hotelling's t test, or a chi-square test) using the normal model. Alternatively, the server may perform the outlier detection on the first information of training time, based on a residual between regression models generated by the first information of training time and the pieces of second information of training time, via a certain method (for example, a robust regression model or an Arima model) using the regression model. Alternatively, the server may perform the outlier detection on the first information of training time via the mixed model, such as a method of applying different statistic distributions on a normal value and an outlier value or a method of applying a mixed statistic distribution only on a normal value.

According to an embodiment of the disclosure, the server may perform the outlier detection on the information of training time by applying the information of training time received from the electronic device to an outlier detection AI model built in the server.

For example, the outlier detection AI model built in the server may perform the outlier detection on the first information of training time, based on a correlation between feature information obtained from the first information of training time and feature information obtained from the pieces of second information of training time about the training time taken by the electronic device to refine the AI model.

As another example, the outlier detection AI model built in the server may learn federated learning auxiliary information of each of a plurality of electronic devices and pieces of information of training time about training times taken by the plurality of electronic devices to train AI models, thereby identifying a correlation between each of elements included in the federated learning auxiliary information and a time taken to train an AI model. The outlier detection AI model built in the server may perform the outlier detection on the first information of training time, based on a correlation between the first information of training time and the federated learning auxiliary information received from the electronic device. The federated learning auxiliary information may include at least one of information about a specification of the electronic device, information about a use rate of hardware used by the electronic device to train the AI model, information about an algorithm used by the electronic device to train the AI model, or information about a size of a federated learning parameter generated as the electronic device trains the AI model.

Referring to operation S650, the server may identify whether the electronic device has trained the AI model, based on a result of performing the outlier detection on the information of training time.

According to an embodiment of the disclosure, the server may identify whether the electronic device has trained the AI model, based on whether the feature (for example, the principal component) of the first information of training time obtained via the PCA and the features (for example, principal components) of the pieces of second information of training time match each other.

According to an embodiment of the disclosure, the server may identify whether the electronic device has trained the AI model, based on whether the distance between the first information of training time and the pieces of second information of training time is equal to or less than a certain value, by applying the first information of training time to the statistic model.

According to an embodiment of the disclosure, the server may identify whether the electronic device has trained the AI model, based on output data of the outlier detection AI model to which the first information of training time is applied.

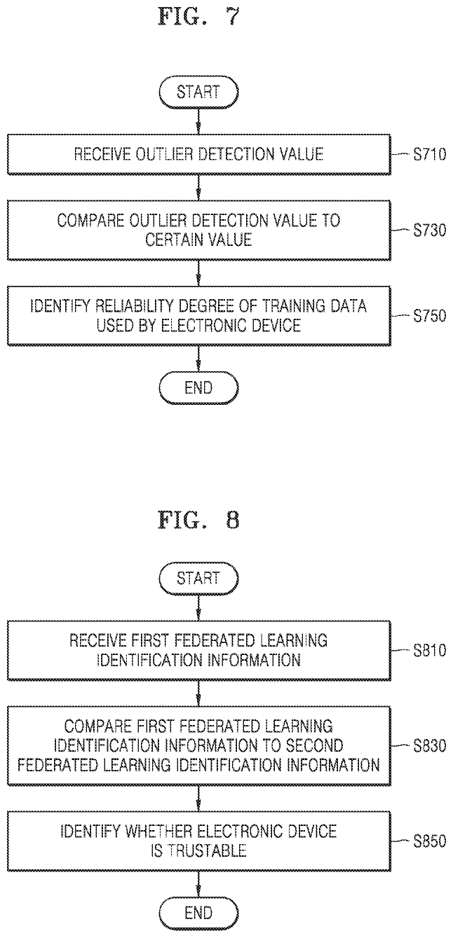

FIG. 7 is a flowchart illustrating an example method, performed by the server, of identifying a reliability degree of training data used by the electronic device that transmitted federated learning data to train the AI model built in the electronic device, according to various embodiments. Referring to FIG. 7, the server may identify the reliability degree of the training data used by the electronic device to train the AI model, based on an outlier detection value received from the electronic device.

According to an embodiment of the disclosure, the electronic device may perform outlier detection on the training data used to train the AI model.

For example, the electronic device may perform the outlier detection via a method, such as a proximity-based technique, an optimized k-NN method, a k-means method, a graph connectivity method, or a parametric method.

As another example, the electronic device may perform outlier detection on first training data by performing PCA on the first training data. The electronic device may obtain an outlier detection value of the first training data by comparing a principal component obtained from the first training data to principal components obtained from a plurality of pieces of second training data used to train AI models.

As another example, the electronic device may obtain the outlier detection value of the first training data via a statistic analysis regarding the first training data. For example, the electronic device may obtain the outlier detection value of the first training data by comparing the first training data to the pieces of second training data. Alternatively, the electronic device may identify a distance between the first training data and the pieces of second training data via at least one of certain methods using a normal model, a regression model, and a mixed model generated from the pieces of second training data.

As another example, the electronic device may obtain the outlier detection value of the first training data by applying the first training data to an outlier detection AI model. For example, the electronic device may identify a correlation between the first training data and the second training data by applying the first training data to the outlier detection AI model trained using the plurality of pieces of second training data. The electronic device may obtain the outlier detection value based on the identified correlation.

According to an embodiment of the disclosure, the electronic device may obtain an outlier detection value of the training data by performing outlier detection on the training data. For example, the electronic device may obtain, as the outlier detection value, a value where the first training data is located in a normal distribution obtained from the plurality of pieces of second training data. As another example, the electronic device may obtain, as the outlier detection value, a deviation between the first training data and a quartile of the plurality of pieces of second training data. As another example, the electronic device may obtain, as the outlier detection value, a value obtained by calculating a local outlier factor (LOF) of the first training data.

According to an embodiment of the disclosure, the electronic device may store the obtained outlier detection value in the secure zone.

Referring to operation S710, the server may receive, from the electronic device, the outlier detection value of the training data used to train the AI model. The electronic device may transmit, to the server, federated learning data including the outlier detection value stored in the secure zone together with a federated learning parameter.

Referring to operation S730, the server may compare the outlier detection value received from the electronic device to a certain value.

For example, the server may compare a first training data value (e.g., the outlier detection value) received from the electronic device with an upper limit UL of Equation 1 and a lower limit LL of Equation 2.

UL=(IQR*1.5)+Q3 [Equation 1]

LL=(IQR*1.5)−Q1 [Equation 2]

Here, Q1 denotes a first quartile point Q1 of quartile points of the second training data, Q3 denotes a third quartile point Q3 of the quartile points of the second training data, and IQR denotes a difference between the first quartile point Q1 and the third quartile point Q3 of the quartile points of the second training data.

As another example, the server may compare the value where the first training data is located in the normal distribution obtained from the plurality of pieces of second training data to a numerical value (for example, 97.5% or 2.5%) indicating a certain range in the normal distribution.

As another example, the electronic device may compare the value obtained by calculating the LOF of the first training data to a value obtained by calculating the LOF of each piece of the second training data.

Referring to operation S750, the server may identify the reliability degree of the training data used by the electronic device to train the AI model, based on a result of comparing the outlier detection value to the certain value.

For example, the server may identify the reliability degree of the first training data, based on a result of comparing the first training data value (e.g., the outlier detection value) received from the electronic device with the upper limit UL of Equation 1 and the lower limit LL of Equation 2. For example, the server may identify that the first training data is not trustable when the first training data value is greater than the upper limit UL of Equation 1 or less than the lower limit LL of Equation 2.

As another example, the server may identify the reliability degree of the first training data, based on a result of comparing the value where the first training data is located in the normal distribution obtained from the plurality of pieces of second training data to the numerical value indicating the certain range in the normal distribution. For example, the server may identify that the first training data is not trustable when the first training data is located in 97.5% or above of the normal distribution or in 2.5% or lower of the normal distribution.

As another example, the server may identify the reliability degree of the first training data, based on a result of comparing the value obtained by calculating the LOF of the first training data to the value obtained by calculating the LOF of each piece of the second training data. For example, the server may identify the reliability degree of the first training data, based on a distance between the LOF of the first training data and a region where the LOFs of the pieces of second training data are concentrated.

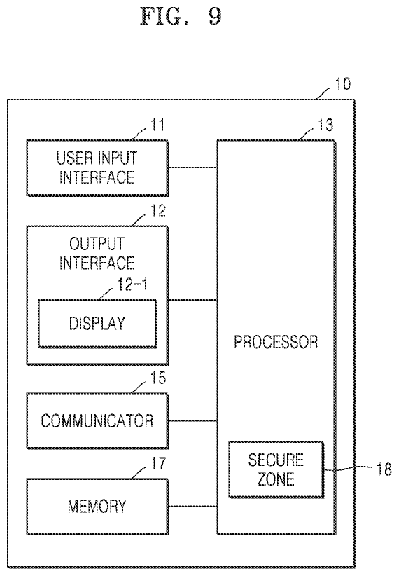

FIG. 8 is a flowchart illustrating an example method, performed by the server, of identifying a reliability degree of the electronic device that transmitted federated learning data, according to various embodiments. Referring to FIG. 8, the server may identify whether the electronic device is trustable, based on the federated learning identification information received from the electronic device.

According to an embodiment of the disclosure, the electronic device may store, in the secure zone, federated learning identification information that is identification information related to federated learning performed with the server. For example, the electronic device may store, in the secure zone, the federated learning identification information, such as identification information of the electronic device, identification information of an application training the AI model built in the electronic device, and identification information of the secure zone. The electronic device may encode the federated learning identification information by applying the same to a hash function. The electronic device may store the encoded federated learning identification information in the secure zone.

Referring to operation S810, the server may receive first federated learning identification information from the electronic device. The electronic device may transmit, to the server, federated learning identification information stored in the secure zone together with a federated learning parameter. The federated learning identification information transmitted by the electronic device to the server may be data encoded by a hash function pre-determined between the electronic device and the server.

Referring to operation S830, the server may compare the first federated learning identification information to second federated learning identification information stored in the server. The server may compare, with the first federated learning identification information received from the electronic device, the second federated learning identification information, such as the identification information of the electronic device, the identification information of the application training the AI model built in the electronic device, and the identification information of the secure zone, which is obtained when transmitting or receiving data for forming a network for federated learning to or from the electronic device.

According to an embodiment of the disclosure, the server may compare the second federated learning identification information encoded using the pre-determined hash function to the encoded first federated learning identification information received from the electronic device.

Referring to operation S850, the server may identify whether the electronic device that transmitted federated learning data is trustable, based on a result of comparing the first federated learning identification information to the second federated learning identification information.

The server may identify that the first federated learning identification information received from the electronic device and the second federated learning identification information registered in the server are the same, thereby identifying that the federated learning data has been received from the electronic device authenticated by the server.

The first federated learning identification information encoded by the hash function and the second federated learning identification information being the same indicates that an integrity of the first federated learning identification information is recognized. Accordingly, the server may identify that the federated learning data has been received from the electronic device authenticated by the server, based on the first federated learning identification information of which the integrity is recognized.

FIG. 9 is a block diagram illustrating an example configuration of the electronic device 10 according to various embodiments.

Referring to FIG. 9, the electronic device 10 may include a user input interface (e.g., including interface circuitry) 11, an output interface (e.g., including interface circuitry) 12, a processor (e.g., including processing circuitry) 13, a communication interface (e.g., including communication circuitry) 15, and a memory 17. However, the components shown in FIG. 9 are not all essential components of the electronic device 10. The electronic device 10 may include more or fewer components than those shown in FIG. 9.

The user input interface 11 is a unit including various interface circuitry into which a user inputs data for controlling the electronic device 10. For example, the user input interface 11 may include a touch screen, a keypad, a dome switch, a touch pad (contact capacitance type, pressure resistive type, an infrared (IR) detection type, surface ultrasonic wave conduction type, integral tension measuring type, piezo-effect type, or the like), jog wheel, a jog switch, or the like, but is not limited thereto.

The user input interface 11 may receive a user input required by the electronic device 10 to perform the embodiments of the disclosure described with reference to FIGS. 1 through 8.

The output interface 12 may include various interface circuitry and outputs information processed by the electronic device 10. The output interface 12 may output information related to the embodiments of the disclosure described with reference to FIGS. 1 through 8. Also, the output interface 12 may include a display 12-1 for displaying an object, a user interface, and a result of performing an operation corresponding to a user input.

The processor 13 may include various processing circuitry and generally controls all operations of the electronic device 10. For example, the processor 13 may execute at least one instruction stored in the memory 17 to generally control the user input interface 11, output interface 12, communication interface 15, and memory 17 to perform federated learning.

For example, the processor 13 may execute an instruction stored in an AI model training module to control the electronic device 10 to train the AI model 19 using training data. Descriptions overlapping those of the embodiments of the disclosure described above with reference to FIGS. 1 through 8 may not be repeated here.

As another example, the processor 13 may execute an instruction stored in a federated learning parameter obtaining module to control the electronic device 10 to obtain a parameter of the refined AI model 19/an updated weight from among weights of neural network layers of the refined AI model 19. Descriptions overlapping those of the embodiments of the disclosure described above with reference to FIGS. 1 through 8 may not be repeated here.

As another example, the processor 13 may execute an instruction stored in an outlier detection performing module to control the electronic device 10 to perform outlier detection on the training data used to train the AI model 19. Descriptions overlapping those of the embodiments of the disclosure described above with reference to FIGS. 1 through 8 may not be repeated here.

As another example, the processor 13 may execute an instruction stored in a federated learning secure data obtaining module to control the electronic device 10 to obtain federated learning secure data for identifying whether a result of training the AI model 19 is able to be trusted by the server 20. Descriptions overlapping those of the embodiments of the disclosure described above with reference to FIGS. 1 through 8 may not be repeated here.

The processor 13 may include at least one processor that is used for general purposes. Also, the processor 13 may include at least one processor manufactured to perform a function of an AI model. The processor 13 may execute a series of instructions such that the AI model learns new training data. The processor 13 may execute a software module stored in the memory 17 to perform functions of the AI model described above with reference to FIGS. 1 through 8.

The communication interface 15 may include one or more components including various communication circuitry enabling the electronic device 10 to communicate with another device (not shown) and the server 20. The other device may be a computing device such as the electronic device 10, but is not limited thereto.

The memory 17 may store at least one instruction and at least one program for processes and controls by the processor 13, and may store data input to or output from the electronic device 10.

The memory 17 may include at least one type of storage media from among memories transitorily storing data, such as random-access memory (RAM) and static RAM (SRAM), and data storages non-transitorily storing data, such as a flash memory type, hard disk type, multimedia card micro type, or card type memory (for example, a secure digital (SD) or an extreme digital (XD) memory), read-only memory (ROM), electrically erasable programmable ROM (EEPROM), programmable ROM (PROM), a magnetic memory, a magnetic disk, and an optical disk.

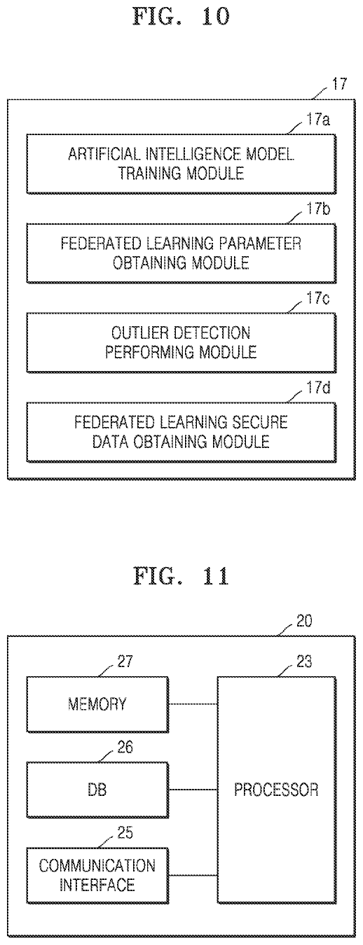

FIG. 10 is a block diagram illustrating an example software module of the memory 17 included in the electronic device 10, according to various embodiments.

Referring to FIG. 10, the memory 17 may include an AI model training module 17a, a federated learning parameter obtaining module 17b, a outlier detection performing module 17c, and a federated learning secure data obtaining module 17d, as software modules including instructions (e.g., executable program instructions) for enabling the electronic device 10 to perform the embodiments of the disclosure described above with reference to FIGS. 1 through 8. However, the electronic device 10 may perform federated learning by more or fewer software modules than those shown in FIG. 10.

For example, the processor 13 may execute the instruction stored in the AI model training module 17a such that the electronic device 10 may train the AI model 19 using training data. Descriptions overlapping those of the embodiments of the disclosure described above with reference to FIGS. 1 through 8 may not be repeated here.

As another example, the processor 13 may execute the instruction stored in the federated learning parameter obtaining module 17b such that the electronic device 10 may obtain a parameter of the refined AI model 19/an updated weight among weights of neural network layers of the refined AI model 19. Descriptions overlapping those of the embodiments of the disclosure described above with reference to FIGS. 1 through 8 may not be repeated here.

As another example, the processor 13 may execute the instruction stored in the outlier detection performing module 17c such that the electronic device 10 may perform outlier detection on training data used to train the AI model 19. Descriptions overlapping those of the embodiments of the disclosure described above with reference to FIGS. 1 through 8 may not be repeated here.

As another example, the processor 13 may execute the instruction stored in the federated learning secure data obtaining module 17d such that the electronic device 10 may obtain federated learning secure data for identifying whether the server 20 may trust a result of training the AI model 19. Descriptions overlapping those of the embodiments of the disclosure described above with reference to FIGS. 1 through 8 may not be repeated here.

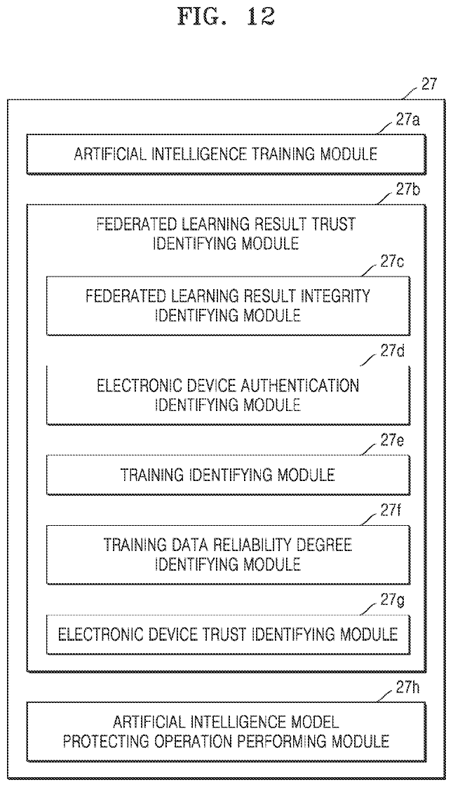

FIG. 11 is a block diagram illustrating an example configuration of the server 20 according to various embodiments.

Referring to FIG. 11, the server 20 according to some embodiments of the disclosure may include a communication interface (e.g., including communication circuitry) 25, a memory 27, a DB 26, and a processor (e.g., including processing circuitry) 23.

The communication interface 25 may include one or more components including various communication circuitry enabling the server 20 to communicate with the electronic device 10.

The memory 27 may store at least one instruction and at least one program for processes and controls by the processor 23, and may store data input to or output from the server 20.

The DB 26 may store data received from the electronic device 10. The DB 26 may store a plurality of training data sets to be used to train an AI model.

The processor 23 may include various processing circuitry and generally controls all operations of the server 20. For example, the processor 23 may execute the programs stored in the memory 27 of the server 20 to control the DB 26 and the communication interface 25 in general. The processor 23 may execute the programs to perform operations of the server 20 described with reference to FIGS. 1 through 8.

For example, the processor 23 may execute an instruction stored in an AI training module to control the server 20 to refine the core AI model 29, based on federated learning data received from the electronic device 10. Descriptions overlapping those of the embodiments of the disclosure described above with reference to FIGS. 1 through 8 may not be repeated here.

As another example, the processor 23 may execute an instruction included in a federated learning result trust identifying module to identify whether a result of federated learning performed by the electronic device 10 is trustable.

For example, the processor 23 may execute an instruction included in a federated learning result integrity identifying module to identify an integrity of a federated learning parameter received from the electronic device 10. Descriptions overlapping those of the embodiments of the disclosure described above with reference to FIGS. 1 through 8 may not be repeated here.

The processor 23 may execute an instruction included in an electronic device authentication identifying module to identify whether the electronic device 10 has been authenticated by the server 20, based on a message authentication code received from the electronic device 10. Descriptions overlapping those of the embodiments of the disclosure described above with reference to FIGS. 1 through 8 may not be repeated here.

The processor 23 may execute an instruction included in a training identifying module to identify whether the electronic device 10 has trained the AI model 19, based on information of training time received from the electronic device 10. Descriptions overlapping those of the embodiments of the disclosure described above with reference to FIGS. 1 through 8 may not be repeated here.

The processor 23 may execute an instruction included in a training data reliability degree identifying module to identify a reliability degree of the training data used by the electronic device 10 to train the AI model 19, based on an outlier detection value received from the electronic device 10. Descriptions overlapping those of the embodiments of the disclosure described above with reference to FIGS. 1 through 8 may not be repeated here.

The processor 23 may execute an instruction included in an electronic device trust identifying module to identify whether the electronic device 10 is trustable, based on federated learning identification information received from the electronic device 10. Descriptions overlapping those of the embodiments of the disclosure described above with reference to FIGS. 1 through 8 may not be repeated here.

As another example, the processor 23 may execute an instruction included in an AI model protecting operation performing module to remove the federated learning parameter received from the electronic device 10 without reflecting the federated learning parameter to federated learning, request the electronic device 10 to retransmit the federated learning parameter, or drop out the electronic device 10 from federated learning. Descriptions overlapping those of the embodiments of the disclosure described above with reference to FIGS. 1 through 8 may not be repeated here.

FIG. 12 is a block diagram illustrating an example software module of the memory 27 included in the server 20, according to various embodiments.

Referring to FIG. 12, the memory 27 may include, as software modules for enabling the server 20 to perform the embodiments of the disclosure described above with reference to FIGS. 1 through 8, an AI training module 27a, a federated learning result trust identifying module 27b, a federated learning result integrity identifying module 27c, an electronic device authentication identifying module 27d, a training identifying module 27e, a training data reliability degree identifying module 27f, an electronic device trust identifying module 27g, and an AI model protecting operation performing module 27h. However, the server 20 may perform federated learning by more or fewer software modules than those shown in FIG. 12.

For example, the processor 23 may execute the instruction stored in the AI training module 27a such that the server 20 may refine the core AI model 29 based on federated learning data received from the electronic device 10. Descriptions overlapping those of the embodiments of the disclosure described above with reference to FIGS. 1 through 8 may not be repeated here.

As another example, the processor 23 may execute the instruction included in the federated learning result trust identifying module 27b such that the server 20 may identify whether a result of federated learning performed by the electronic device 10 is trustable.

For example, the processor 23 may execute the instruction included in the federated learning result integrity identifying module 27c such that the server 20 may identify an integrity of a federated learning parameter received from the electronic device 10. Descriptions overlapping those of the embodiments of the disclosure described above with reference to FIGS. 1 through 8 may not be repeated here.

The processor 23 may execute the instruction included in the electronic device authentication identifying module 27d such that the server 20 may identify whether the electronic device 10 has been authenticated by the server 20, based on a message authentication code received from the electronic device 10. Descriptions overlapping those of the embodiments of the disclosure described above with reference to FIGS. 1 through 8 may not be repeated here.

The processor 23 may execute the instruction included in the training identifying module 27e such that the server 20 may identify whether the electronic device 10 has trained the AI model 19, based on information of training time received from the electronic device 10. Descriptions overlapping those of the embodiments of the disclosure described above with reference to FIGS. 1 through 8 may not be repeated here.

The processor 23 may execute the instruction included in the training data reliability degree identifying module 27f such that the server 20 may identify a reliability degree of the training data used by the electronic device 10 to train the AI model 19, based on an outlier detection value received from the electronic device 10. Descriptions overlapping those of the embodiments of the disclosure described above with reference to FIGS. 1 through 8 may not be repeated here.

The processor 23 may execute the instruction included in the electronic device trust identifying module 27g such that the server 20 may identify whether the electronic device 10 is trustable, based on federated learning identification information received from the electronic device 10. Descriptions overlapping those of the embodiments of the disclosure described above with reference to FIGS. 1 through 8 may not be repeated here.

As another example, the processor 23 may execute the instruction included in the AI model protecting operation performing module 27h such that the server 20 may remove the federated learning parameter received from the electronic device 10 without reflecting the federated learning parameter to federated learning, request the electronic device 10 to retransmit the federated learning parameter, or drop out the electronic device 10 from federated learning. Descriptions overlapping those of the embodiments of the disclosure described above with reference to FIGS. 1 through 8 may not be repeated here.

A machine-readable storage medium may be provided in the form of a non-transitory storage medium. Here, the ‘non-transitory storage medium’ refers to a tangible device and may not contain a signal (for example, electromagnetic waves). This term does not distinguish a case where data is stored in the storage medium semi-permanently and a case where the data is stored in the storage medium temporarily. For example, the ‘non-transitory storage medium’ may include a buffer where data is temporarily stored.

According to an embodiment of the disclosure, a method according to various embodiments of the disclosure may be provided by being included in a computer program product. The computer program products are products that can be traded between sellers and buyers. The computer program product may be distributed in a form of machine-readable storage medium (for example, a compact disc read-only memory (CD-ROM)), or distributed (for example, downloaded or uploaded) through an application store (for example, Play Store™) or directly or online between two user devices (for example, smartphones). In the case of online distribution, at least a part of the computer program product (for example, a downloadable application) may be at least temporarily generated or temporarily stored in a machine-readable storage medium, such as a server of a manufacturer, a server of an application store, or a memory of a relay server.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method, performed by a server, of performing federated learning with an electronic device, the method comprising:
transmitting, to the electronic device, requesting data requesting transmission of a federated learning parameter used to refine a core artificial intelligence model built in the server;
receiving, from the electronic device, federated learning data including the federated learning parameter;
identifying whether a result of federated learning performed by the electronic device is trustable, based on the federated learning data; and
refining the core artificial intelligence model, based on a result of the identifying,
wherein the receiving of the federated learning data comprises receiving federated learning secure data stored in a hardware secure architecture of the electronic device, and
the identifying of whether the result of the federated learning is trustable comprises identifying whether the result of the federated learning is trustable, based on the federated learning secure data.

2. The method of claim 1, wherein the receiving of the federated learning secure data comprises receiving first hash data of the federated learning parameter stored in the hardware secure architecture of the electronic device, and
the identifying of whether the result of the federated learning is trustable comprises:
obtaining second hash data from the federated learning parameter received from the electronic device; and
identifying an integrity of the result of the federated learning by comparing the first hash data to the second hash data.

3. The method of claim 1, wherein the receiving of the federated learning secure data comprises receiving, by the electronic device, the federated learning secure data including federated learning performance information about a result of performing training on an artificial intelligence model built in the electronic device, and
the identifying of whether the result of the federated learning is trustable comprises identifying whether the result of the federated learning is trustable, based on the federated learning performance information.

4. The method of claim 3, wherein the federated learning performance information comprises information of training time about a time taken by the electronic device to perform the training on the artificial intelligence model built in the electronic device, and
the identifying of whether the result of the federated learning is trustable comprises identifying whether the electronic device has trained the artificial intelligence model built in the electronic device, by performing outlier detection on the information of training time.

5. The method of claim 3, wherein the federated learning performance information comprises an outlier detection value generated based on outlier detection being performed on training data used by the electronic device to train the artificial intelligence model built in the electronic device, and
the identifying of whether the result of the federated learning is trustable comprises identifying a reliability degree of the training data used by the electronic device by comparing the outlier detection value to a certain value.

6. The method of claim 3, wherein the federated learning performance information comprises federated learning identification information including identification information related to the federated learning performed by the electronic device, and
the identifying of whether the result of the federated learning is trustable comprises identifying whether the electronic device is trustable, based on first federated learning identification information received from the electronic device and second federated learning identification information pre-registered in the server.

7. The method of claim 1, wherein the refining of the core artificial intelligence model comprises performing a protecting operation on the core artificial intelligence model, based on the result of the federated learning identified to be untrustable.

8. A server configured to perform federated learning with an electronic device, the server comprising:
a communication interface comprising communication circuitry;
a memory storing one or more instructions; and
a processor configured to execute the one or more instructions to:
control the communication interface to transmit, to the electronic device, requesting data requesting transmission of a federated learning parameter used to refine a core artificial intelligence model built in the server and receive, from the electronic device, federated learning data including the federated learning parameter;
identify whether a result of the federated learning performed by the electronic device is trustable, based on the federated learning data;
refine the core artificial intelligence model, based on a result of the identifying;
control the communication interface to receive federated learning secure data stored in a hardware secure architecture of the electronic device; and
identify whether the result of the federated learning is trustable, based on the federated learning secure data.

9. The server of claim 8, wherein the processor is further configured to execute the one or more instructions to:
control the communication interface to receive first hash data of the federated learning parameter stored in the hardware secure architecture of the electronic device;
obtain second hash data from the federated learning parameter received from the electronic device; and
identify an integrity of the result of the federated learning by comparing the first hash data to the second hash data.

10. The server of claim 8, wherein the processor is further configured to execute the one or more instructions to:
control the communication interface to receive the federated learning secure data including federated learning performance information about a result of performing, by the electronic device, training on an artificial intelligence model built in the electronic device; and
identifying whether the result of the federated learning is trustable, based on the federated learning performance information.

11. The server of claim 10, wherein the federated learning performance information comprises information of training time about a time taken by the electronic device to perform the training on the artificial intelligence model built in the electronic device, and
the processor is further configured to execute the one or more instructions to identify whether the electronic device has trained the artificial intelligence model built in the electronic device, by performing outlier detection on the information of training time.

12. The server of claim 10, wherein the federated learning performance information comprises an outlier detection value generated based on outlier detection being performed on training data used by the electronic device to train the artificial intelligence model built in the electronic device, and
the processor is further configured to execute the one or more instructions to identify a reliability degree of the training data used by the electronic device by comparing the outlier detection value to a certain value.

13. The server of claim 10, wherein the federated learning performance information comprises federated learning identification information including identification information related to the federated learning performed by the electronic device, and
the processor is further configured to execute the one or more instructions to identify whether the electronic device is trustable, based on first federated learning identification information received from the electronic device and second federated learning identification information pre-registered in the server.

14. The server of claim 8, wherein the processor is further configured to execute the one or more instructions to perform a protecting operation on the core artificial intelligence model, based on the result of the federated learning identified to be untrustable.
